(19) United States
(12) Patent Application Publication
(10) Pub. No.: US 2009/0047077 A1
(43) Pub. Date: Feb. 19, 2009

(54) Tool Holder and Method for Machining Apparatus

(76) Inventor: Billy Fielder, Houston, TX (US)

Correspondence Address: KENNETH L. NASH, P.O. BOX 680106, HOUSTON, TX, 77268-0106, US

(21) Appl. No.: 11/837,617

(22) Filed: Aug. 13, 2007

(51) Int. Cl. B26D 5/00

(52) U.S. Cl. 407/87; 29/592; 407/102; 407/77

(57) ABSTRACT

An expandable/compressible slot and/or opening may be formed by machining a tool holder body. The slot and/or opening may receive a tool and secure it therein utilizing the inner surface of the slot and/or opening. Adjustment members may be utilized for compressing and/or expanding the slot and/or opening to permit insertion and/or removal of the tool.

### BACKGROUND OF THE INVENTION

1. Field of the Invention

The present invention relates generally to a machining apparatus and, more particularly, to a tool holder for a machining apparatus.

2. Description of the Background

Tool holders are well known for use in machine tools to hold cutting tools and the like during machining operations. Chucks and/or collets are often utilized as tool holders. Such tool holders usually grip a cutting tool over a relatively small size gripping surface. Tool holders are subject to considerable forces, vibration, and the like. If the small gripping surface is not sufficiently strong, then adjustments and alignments of cutting tools may deviate from their desired position. The use of a tool holder with a lathe turret is likely to increase these problems. It would be desirable to provide an improved tool holder which is substantially impervious to the problems of prior art tool holders, including tool holders for lathe turrets.

The following prior art discloses patents that attempt to solve the above and/or related problems:

U.S. Pat. No. 5,345,846, issued to Somma, on Sep. 13, 1994, discloses a form tool for a rotating workpiece comprising a removable resharpenable tool insert, a tool holder with a recess receiving the insert, and an adjustable tool insert support, which will raise and relocate the insert in the tool holder recess after each resharpening. Preferably the tool insert support comprises one or more wedge-shaped members drawn into the recess with bolts, serving to clamp the resharpenable insert against the rear wall and top shelf of the recess. The resharpenable tool insert has a top planar surface adapted to be removed during resharpening, a rear surface and a profiled front form surface parallel to the rear surface. The front form surface intersects the top surface at a first included angle which is the complement of the sum of a preselected top rake angle “R” and a preselected front clearance angle “C”. The tool holder recess has an overhanging shelf for locating the top planar surface of the insert and a rear wall for locating the rear surface of the insert, the rear wall and shelf forming a second included angle which is the supplement of the first included angle. A pair of sidewalls locate the form tool longitudinally in the recess and permit a range of form tools of different profiles with the same tool holder.

U.S. Pat. No. 5,848,562, issued to Somma, on Dec. 15, 1998, discloses a side operated clamp for a resharpenable insert tool holder that includes a clamping member movable into a converging recess on the tool holder body to clamp the tool insert against a shelf on the tool holder body. An actuator is movable transversely in a transverse slot extending across the tool holder. A threaded member is rotated to cause the actuator to move. The actuator has a projecting portion fitting into a dovetail keyway on the clamping member. The keyway is inclined to the transverse axis to cause clamping/unclamping movement when the actuator moves in the transverse slot.

U.S. Pat. No. 6,865,789, issued to Katoh et al, on Mar. 15, 2005, discloses a tool holder for attaching a complex tool having a plurality of kinds of cutting edges to a turret, has a base portion attachably and detachably formed at the turret. The base portion has a rotatable tool spindle attachably and detachably installing the complex tool thereon. The tool spindle is provided with indexing means for indexably rotating the tool spindle at an indexed position corresponding to each cutting edge of the complex tool. And, clamping means for clamping the tool spindle at a predetermined indexed position is provided. Indexing rotational function and clamping function owned by the tool holder makes the use of the complex tool in the lathe possible.

U.S. Pat. No. 5,417,131, issued to Robertson, on May 23, 1995, discloses a tool holder adapted to be inserted within the tool slot of a lathe turret. The tool holder includes a detachable cutting unit and a clamping unit. Forming a part of the clamping unit is a pair of wedge blocks disposed within wedge cavities formed within the clamping unit. The wedge blocks are movable via screws from an inner relaxed or disengaged position to an outer position where the wedge blocks engage the tool slot and through a wedging action function to secure the tool holder within the tool slot of the lathe turret.

U.S. Pat. No. 5,888,030, issued to Retondo, on Mar. 30, 1999, discloses a circular insert tool holder assembly for use with a circular tool post and for holding a resharpenable insert tool which has a top surface, a bottom surface, a front surface and a rear surface and having a cutting edge defined by the line formed by the intersection of the front surface and top surface of the insert tool, comprises a tool holder body, structure for rotatably mounting the tool holder body to the circular tool post, the tool holder body having a cavity therein, the cavity having an upper portion and a lower portion, the lower cavity portion being defined by an upper wall and a rear wall, and, a mechanism for retaining the insert tool within the upper cavity portion whereby the top surface of the insert tool is positioned along the upper wall of the cavity.

U.S. Pat. No. 6,938,527, issued to Motl, on Sep. 6, 2005, discloses a material stock advancing apparatus for use with a turning and milling machine having a computerized numeric controller or lacking programmable capabilities. The material stock advancing apparatus generally comprising an elongate body of cylindrical form having first and second ends and an interior chamber for housing therein a plunger assembly operably working therewithin. The second end comprising means for attaching the elongate body to an external holding device such as a collet or chuck adapter seated in a headstock spindle assembly. The first end comprising an end plug having a threaded section situated in between external and internal ends thereof, with the threaded section being threadably attached to the first end to permit the internal end to substantially engage a portion of the plunger assembly and ensure proper axial positioning of the plunger assembly during cyclic operation. The plunger assembly comprising a ram operably acting longitudinally within the interior chamber of the elongate body via biasing means comprising at least one spring operably acting in conjunction with controller means used in opening and closing the external holding device, which collectively controls the advancement of material stock toward and beyond the second end to permit the machining thereof for conversion into a useful product.

U.S. Pat. No. 6,918,717, issued to Ben-Mucha, on Jul. 19, 2005, discloses a tool for the machine working of workpieces for universal machines, which automatically work very small workpieces by different lathe working operations. A cutting insert can be fixed in a tool holder by means of a fixing screw. The cutting insert is constructed as a reversing plate and has two conical receptacles for the conical gripping head of the fixing screw. This reversing plate has several use possibilities, such as grooving, plunge and turn, threading, front turn, back turn and cut off. The central opening in the cutting insert is connected by means of a slot to the narrower trapezoidal surface of the cutting insert, the slot being sufficiently wide to fit over the shank of the fixing screw. Thus, after loosening the fixing screw, the cutting insert can be removed laterally and correspondingly fitted again. The screw is captive and can also be operated from the back of the tool holder.

U.S. Pat. No. 6,880,436, issued to Schlitters, on Apr. 19, 2005, discloses a shave tool holder for use with an automatic screw machine and for machining a rotatably driven workpiece. The tool holder includes a shank engageable with the screw machine and for providing reciprocating motion of the shave tool holder. A dovetail shaped recess is defined within a forward mounting portion of the shank and a corresponding dovetail shaped projection in an opposing surface of the body in order to engage the body with the shank in a vertically deflectable and adjustable manner. A roller is secured in vertically adjustable fashion to a forward facing location of the body. A tool post is releasably secured to the body, through aligning apertures formed in the body and the tool post, a mounting bolt inserting through the aligning apertures for securing the tool post to the body. A cutting insert is secured upon the tool post in a desired spaced relationship relative to the roller and so that the rotatably driven workpiece is adapted to being received between the roller and the insert.

U.S. Pat. No. 6,813,980, issued to Inayama, on Nov. 9, 2004, discloses a cutting tool that is disposed on a turret. The cutting tool includes: a holder having a peak end, and a throw-away insert clamped to the peak end of the holder with a clamp screw. The holder has a bottom face and a peak end face defining a corner of the holder. The corner of the holder forms a chamfered face. The throw-away insert has a bottom face and a relief face defining a corner of the throw-away insert. The corner of the throw-away insert forms a chamfered face. The chamfered face of the corner of the holder and the chamfered face of the corner of the throw-away insert prevent the cutting tools adjacent to each other from causing an interference with each other when the cutting tools are at least one of in a standby position and in a machining operation.

U.S. Pat. No. 6,715,386, issued to Maier, on Apr. 6, 2004, discloses a novel turning method on a lathe or a machining apparatus that uses a tool head which is traversable for the machining and can be rotated mechanically in a receiver with a rotary axis D in the course of the machining. The rotary axis D of the tool head lies within an angular range of 45 degrees to 90 degrees to the X-axis and perpendicularly to the Z-axis of the machining apparatus. In addition, a tool head is used whose cutting inserts are arranged in such a way that each cutting insert has a tool reference plane Pᵣ through in each case identical selected cutting-edge points perpendicularly to the assumed cutting direction in accordance with DIN 6581, this tool reference plane Pᵣ running within an angular range of 90 degrees to 135 degrees to the rotary axis D of the tool head.

U.S. Pat. No. 6,612,004, issued to Yamazaki et al, on Sep. 2, 2003, discloses a complex machining machine tool, with a tool rest capable of attachably and detachably installing tool installing inserts thereon; a plural number of virtual tools is set and registered concerning a predetermined at least one tool together with its indexing positional data in tool file, the tool data of the corresponding virtual tool is read out from the tool file on the basis of the machining instruction by the virtual tool stored in machining program, and the corresponding virtual tool is indexed on the tool rest on the basis of the indexing positional data, and then machining with the virtual tool is executed. At the time of machining, it is possible to continue machining with the same tool by only positional indexing without changing the tool. The work for changing tools can be extremely decreased even if machining contents are changed or it is necessary to change tools by tool exhaustion.

U.S. Pat. No. 6,234,731, issued to Sakamoto, on May 22, 2001, discloses an angle spindle attachment that includes a spindle shaft for mounting a tool detachably, a housing for mounting the spindle shaft rotatably such that the spindle shaft is oriented to a different direction with respect to the drive shaft of the spindle unit, a gear train for transmitting the drive power of the spindle unit to the spindle shaft of the angle spindle attachment. A collet means for retaining and releasing the tool that is movable between a position for retaining the tool and a position for releasing the tool so as to interlock the rotation of the spindle shaft, and a switching means for switching the collet means between a operative condition to permit the tool to be retained and released and an inoperative condition for mounting the tool undetachably.

U.S. Pat. No. 6,128,812, issued to Link et al, on Oct. 10, 2000, discloses a tool turret for a machine tool, in particular, a lathe, comprising a turret head rotatable about a turret indexing axis, the turret head tapering on either side of a diameter plane of the turret head extending perpendicularly to the turret indexing axis and having on each side of this diameter plane a circular ring-shaped row of tool stations which is concentric with the indexing axis, each of the tool stations having a tool receiving means for clamping a toolholder for a machining tool, in order to increase the machining operations which are performable with a tool turret and the machining accuracy, such a tool turret is so designed that: each tool station comprises a planar contact surface formed by the outer surfaces of the turret head for a toolholder; the contact surfaces of the two rows of tool stations define regular pyramids of identical shape which point away from one another and whose axes coincide with the turret indexing axis; each row of tool stations has at least one tool receiving means for a drivable tool, and the axis of the tool receiving means extends perpendicularly to the contact surface of the respective tool station; and two adjacent tool receiving means for drivable tools belong to different rows of tool stations and are offset from one another with respect to angle of rotation in relation to the turret indexing axis.

U.S. Pat. No. 5,752,706, issued to Hodges, on May 19, 1998, discloses a tool holder for machine tools which provides for both angular and radial alignment of the tool with respect to the working axis of the machine. A tool chuck is part of a ball and socket unit, with the ball being pivotable within the socket for angular alignment of the tool chuck and tool carried therein. The base of the socket member is movably carried within a cup-shaped housing of a base member which allows for adjustment in the vertical plane and radial alignment.

U.S. Pat. No. 5,201,613, issued to Jeffery, on Apr. 13, 1993, discloses a single point adjustable triangular carbide cutting insert holder that is designed to clamp the cutting insert with maximum possibility for regrind or grinding for secondary operations. The insert holder is arranged for use in a milling machine and is collet-mounted by its shank. The jaw clamps can be removed for placement of the cutting insert between them, and are then refitted in the cavity where they are tightened by adjustment of a screw. As the screw is tightened, the jaw clamps are drawn further within the cavity, and are rigidly clamped against the cavity walls by frictional contact. When partially released, the jaws can be rotated within the cavity, enabling direct adjustment of the cutting insert rake and relief angle as desired. The cutting insert is seated between the jaw clamps on a seating cam mounted at an edge of the inner jaw face, such that the exposed portion of the cutting insert is a maximum. Thus, the exposed portion can be reground without removing the cutting insert from the holder, allowing for re-use of chipped, burnt and used up carbide cutting inserts. The ability to re-use “throw away” cutting inserts which have been reground makes the inventive insert holder economically attractive for use in many machining operations. The insert holder can also be used on a lathe, with the addition of a split sleeve on the shank. A feature of the invention is the provision of a gauge accessory to quickly check the cutting edge lead and clearance angle, especially useful with cutting insert regrinds.

U.S. Pat. No. 4,084,462, issued to Grinage, on Apr. 18, 1978, discloses a new and improved arrangement for clamping a tool block in a tool supporting ram. The new clamping means provides a firm support for the tool block and further includes means for equalizing the clamping forces applied to the tool block and for properly positioning and orienting the tool block in the ram. In accordance with a specific feature of the present invention, the tool block is provided with clamp engaging means on opposite sides thereof and the clamping means comprises a pair of spaced clamping bars engageable with the respective clamping means on the tool block. A common actuating means is operative to move the clamping bars into a tight clamping relation with the clamping means of the tool block. Means are provided for effectively distributing the clamping force applied by the actuating means which comprise a first connecting means for yieldably interconnecting the actuating means to one of the clamping bars and a second connecting means for non-yieldably interconnecting the actuating means to the other of the clamping bars. The non-yieldable second connecting means is arranged on the side of the tool block from which the work approaches.

U.S. Pat. No. 4,061,061, issued to Lahm et al, on Dec. 6, 1977, discloses a lathe apparatus which, in one form, is an automatic turret lathe in which a single turret head is provided that can support a plurality of tools for performing machining operations on inside and outside surfaces of a workpiece carried on the live spindle of the lathe. The axis of the turret head is disposed at a preferred angular relationship to the axis of the live spindle, and the receiving or mounting surfaces for the inside and outside machining tools are disposed alternately around the axis of the turret head in planar arrangements that provide optimum operating conditions for utilizing the outside and inside machining tools on a single turret head. An attachment for preturning of workpieces is provided which can be mounted on the headstock to perform cutting operations wherein the cutting tool is moved in response to movement of the turret carriage of the turret head. Another attachment is provided to facilitate supporting of the workpiece during the preturning of the workpiece. The lathe apparatus also includes a tailstock construction for synchronous axial adjustment with the live spindle and also to permit pivotal movement of the tailstock relative to the live spindle. An improved automatic feed of bar stock is also provided.

U.S. Patent Publication No. 2005/0046125, to Schuster, published on Mar. 3, 2005, discloses a clamping chuck head for clamping a workpiece to be processed. The clamping chuck head comprises a rotatably supported clamping chuck having a first set of clamping segments for clamping a workpiece on a first perimeter area, an operating device for operating the first set of clamping segments, wherein the operating device comprises at least one spring element which closes the first set of segments for clamping the workpiece due to its bias; and a main sleeve in which the first set of segments is arranged, wherein the main sleeve is rotatably supported in the clamping chuck head on two bearings axially spaced from each other and the operating device is essentially arranged in an axial direction between the two bearings or in the area of the bearings.

The above cited art does not provide a tool holder that sufficiently solves the above-described problems, and which may conveniently be utilized in the turret of a lathe. Those skilled in the art have long sought and will appreciate the present invention which addresses these and other problems.

### SUMMARY OF THE INVENTION

It is an object of the present invention to provide an improved tool holder.

It is yet another object of the present invention to provide a tool holder that may be utilized to reliably secure tools to a lathe turret.

These and other objects, features, and advantages of the present invention will become apparent from the drawings, the descriptions given herein, and the appended claims. However, it will be understood that the above-listed objectives and/or advantages of the invention are intended only as an aid in quickly understanding aspects of the invention, are not intended to limit the invention in any way, and therefore do not form a comprehensive or restrictive list of objectives, and/or features, and/or advantages.

Accordingly, one embodiment of the present invention comprises a tool holder for holding a tool for use with a machining apparatus. In one possible embodiment, the present invention may comprise a tool holder body. The tool holder body may comprise a machined component which preferably comprises a monolithic portion. The monolithic portion defines therein a variable size slot leading to a variable size tool-receiving opening for receiving the tool. The variable size slot and the variable size tool-receiving opening are expandable and/or compressible for receiving and securing different sizes of tools.

In a preferred embodiment, the variable size slot and the variable size tool-receiving opening may be machined into the monolithic portion. The slot preferably opens at an end of the tool holder body and/or may be positioned between the opening and the end of the tool holder portion.

The tool holder might further comprise at least one threaded member intersecting with the slot. In one embodiment, the tool holder may further comprise at least two threaded members operably mounted for opening and closing the variable size slot and the variable size tool receiving opening.

The variable size tool-receiving opening may be defined by walls, which may comprise a relatively soft metal for gripping the tool within the variable size tool-receiving opening.

In another embodiment, the present invention may provide a method for making a tool holder for holding a tool for use with a machining apparatus. The method may comprise steps such as providing a monolithic metallic member, and/or machining a slot in one end of a monolithic metallic member, and/or machining a tool-receiving opening for receiving the tool at one end of a slot. The method may further comprise providing at least one adjustment member to vary a size of the slot and thereby vary a size of the tool receiving opening and/or may further comprise mounting two adjustment members so as to be operable for expanding and compressing the slot and thereby vary a size of the tool receiving opening. In one embodiment, the method may comprise providing that the walls of the tool-receiving opening comprise a relatively soft metal to enhance gripping of the tool within the tool-receiving opening.

In yet another embodiment, the invention may comprise a monolithic tool holder body portion that defines a variable size opening therein for receiving and securing the tool therein and at least one adjustment member operable for varying a size of the opening.

### BRIEF DESCRIPTION OF THE DRAWINGS

FIG. 1 is a side elevational view, partially in section, of a tool holder in accord with one possible embodiment of the present invention;

FIG. 2 is a top view of the tool holder of FIG. 1 in accord with one possible embodiment of the present invention;

FIG. 3 is a schematic view of a lathe tool having a turret on which may be mounted a tool holder in accord with one possible embodiment of the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention and as defined in the appended claims.

### DETAILED DESCRIPTION OF THE PREFERRED EMBODIMENTS

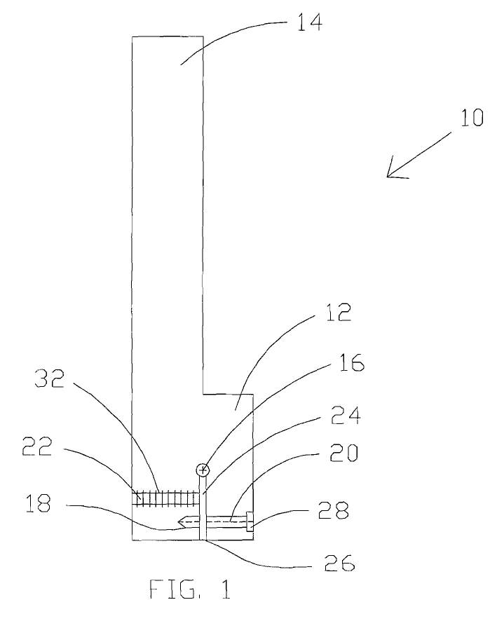

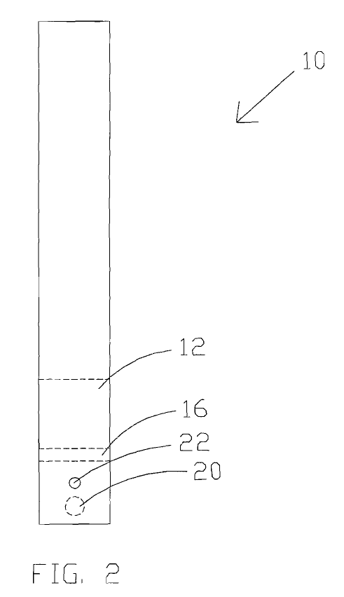

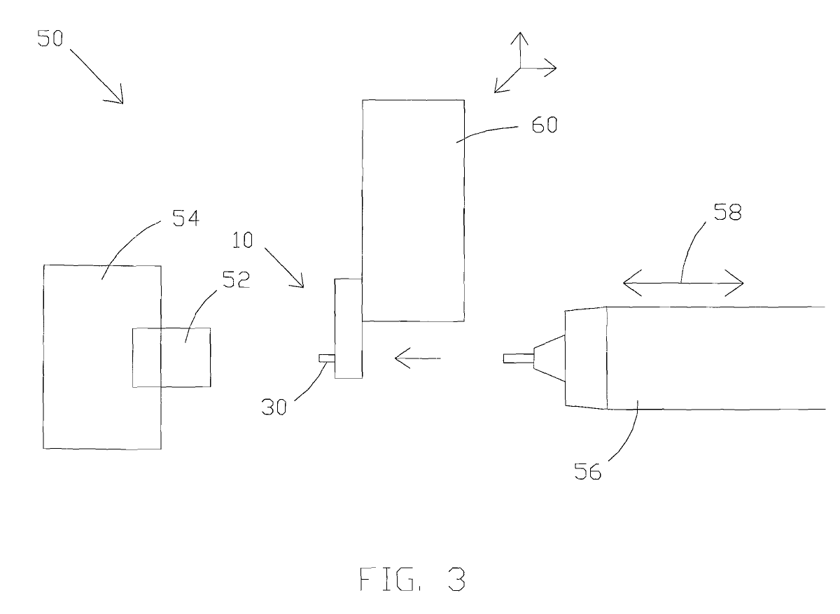

Referring now to the figures, and more particularly to FIGS. 1 and 2, there is shown tool holder 10 in accord with one embodiment of the present invention. Tool holder 10 may be secured at end 14 for use in a machining apparatus such as lathe 50 shown in FIG. 3. While many different configurations of machining devices are possible, in the configuration of lathe 50, workpiece 52 is held in place by chuck 54. Tailstock 56 may move inwardly and outwardly as indicated by arrow 58. Turret 60 may hold a variety of different tools such as tool holder 10 and cutting tool 30 mounted therein. Turret 60 may be programmed to rotate and position cutting tool 30 to perform a desired machining operation. In this general lathe configuration, tool holder 10 might be mounted on the front or perimeter of turret 60. Tools could be mounted on both sides of turret 60. For instance, two tool holders 10 in accord with the present invention might be mounted on opposite sides of turret 60.

Tool holder 10 may comprise preferably end portion 12 that may be used for supporting a tool such as cutting tool 30 shown in FIG. 3. In a preferred embodiment, end portion 12 provides a monolithic portion that defines slot 24 and tool receiving opening 16, which preferably extend through cutting tool 30 (see for instance opening 16 in FIG. 2). Because opening 16 is relatively lengthy, and because the entire inner surface of opening 16 can be utilized to grip cutting tool 30, the present invention greatly increases the gripping strength of tool holder 10.

In other words, end portion 12 is a one-piece construction or piece of metal into which a variable opening is formed. In a preferred embodiment, the variable opening comprises slot 24 and circular opening 16 which is connected to slot 24. Slot 24 opens at opening 26 to an outermost end or surface of end portion 12, thereby permitting slot 24 to expand or contract. By expanding or contracting slot 24, receiving opening 16 can be increased or decreased in size. Thus, opening 16 can accept different size cutting tools. The inherent strength of a monolithic section of metal, such as steel or the like, can be used to support cutting tool 30. End portion 12 may also be enlarged as shown to provide further support for cutting tool 30.

Although various adjustment members may be utilized for expanding or contracting slot 24, in one preferred embodiment two threaded screws may be utilized. For contracting or closing slot 24, screw 20 may engage threads 18 so that head 28 of screw 20 urges slot 24 to contract as screw 20 is rotated. The resulting clamping action holds cutting tool 30 very securely. In order to enlarge or open slot 24, screw 22 may be rotated within threaded portion 32 such that the end of screw 22 then moves against the wall of slot 24 and urges slot 24 to open. In this way, cutting tool 30 may be of different sizes and may be removed or inserted.

While opening 16 may be round, opening 16 may have various shapes as desired and may be shaped so as to mate with a size of cutting tool 30. However, in many cases cutting tool 30 may comprise a round shank that is easily gripped by tool holder 10 when opening 16 is compressed.

In one preferred embodiment, end portion 12 and especially the walls of opening 16 may comprise a relatively soft metal as compared to the very hard metals which are normally utilized to form cutting tool 30. The use of a softer metal adds to the frictional gripping strength of tool holder 10.

Accordingly, the foregoing disclosure and description of the invention is illustrative and explanatory thereof, and it will be appreciated by those skilled in the art, that various changes in the ordering of steps, ranges, and/or attributes and parameters, as well as in the details of the illustrations or combinations of features of the methods and apparatus discussed herein, may be made without departing from the spirit of the invention.

What is claimed is:

1. A tool holder for holding a tool for use with a machining apparatus, comprising:
a tool holder body comprising a monolithic portion, said monolithic portion defining therein a slot leading to a tool-receiving opening for receiving said tool, said slot and said tool-receiving opening being expandable and compressible for receiving and securing different sizes of said tool.

2. The tool holder of claim 1, wherein said slot and said tool-receiving opening are machined into said monolithic portion.

3. The tool holder of claim 1, wherein said slot opens at an end of said tool holder body.

4. The tool holder of claim 3, where said slot is positioned between said opening and said end of said tool holder portion.

5. The tool holder of claim 1, further comprising at least one threaded member intersecting with said slot.

6. The tool holder of claim 1 further comprising at least two threaded members operably mounted for opening and closing said slot and said tool-receiving opening.

7. The tool holder of claim 1 wherein said tool receiving opening is defined by walls comprising a relatively soft metal for gripping said tool within said tool-receiving opening.

8. A method for making a tool holder for holding a tool for use with a machining apparatus, comprising:
providing a monolithic metallic member;
machining a slot in one end of said monolithic metallic member; and
machining a tool-receiving opening for receiving said tool at one end of said slot.

9. The method of claim 8, further comprising:
providing at least one adjustment member to vary a size of said slot and thereby vary a size of said tool-receiving opening.

10. The method of claim 8, further comprising mounting two adjustment members so as to be operable for expanding and compressing said slot and thereby vary a size of said tool receiving opening.

11. The method of claim 8, further comprising providing that walls that define said tool receiving opening comprise a relatively soft metal to enhance gripping of said tool within said tool-receiving opening.

12. A tool holder for holding a tool for use with a machining apparatus, comprising
a tool holder body comprising a monolithic portion wherein an opening has been machined therein for receiving and securing said tool therein; and
at least one adjustment member operable for varying a size of said opening.

13. The tool holder of claim 12, wherein said opening comprises a slot leading to a tool-receiving portion of said opening.

14. The tool holder of claim 13, wherein said slot and said tool-receiving portion of said opening are machined into said monolithic portion.

15. The tool holder of claim 12, wherein said opening is formed at an end of said tool holder body.

16. The tool holder of claim 12, further comprising at least two threaded adjustment members operably mounted for opening and closing said tool opening.

17. The tool holder of claim 12, wherein said opening is defined by walls comprising a relatively soft metal for gripping said tool within said opening.
